(19) United States
(12) Patent Application Publication
(10) Pub. No.: US 2007/0207782 A1
(43) Pub. Date: Sep. 6, 2007

(54) Multimedia telephone

(76) Inventor: Bao Q. Tran, San Jose, CA (US)

Correspondence Address: TRAN & ASSOCIATES, 6768 MEADOW VISTA CT., SAN JOSE, CA, 95135, US

(21) Appl. No.: 11/369,028

(22) Filed: Mar. 6, 2006

(51) Int. Cl. H04N 7/14; H04Q 7/38; H04Q 7/22; H04M 3/42

(52) U.S. Cl. 455/414.1; 348/14.01

(57) ABSTRACT

Systems and methods are disclosed to provide custom dial tone based on user preference; to provide ring back video (RBV) to a caller by selecting a video clip as a ring video for the caller and playing the video clip to the caller in response to an incoming call to the mobile device; or to record a message from a caller as video mail when no one answers the call. The system provides glanceable news, weather, etc. in either text or video format. The system is also multi-protocol and can work with a variety of cellular networks, WiFi networks, and WiMAX networks.

This application is related to application Ser. No. 11/340,336 entitled “CELLULAR DEVICE WITH BROADCAST RADIO OR TV RECEIVER,” application Ser. No. 11/323,789 entitled “WIRELESS MOBILE VIDEO”, and application Ser. No. ______ entitled “SPOKEN MOBILE ENGINE”, the contents of which are incorporated by reference.

### BACKGROUND

Advances in cell phone technology have enabled mobile TV phones to reach mass market. For example, Samsung's SGH-P900 is a Terrestrial Digital Media Broadcasting phone that combines many multimedia features such as TV & radio capabilities, a 2 megapixel camera and a MP3 player. To receive TV signals, users can flip an LCD screen to a horizontal position for optimal viewing. With a QVGA (240×320 pixels) resolution screen with 262,144 colors, TV images are clear, crisp and flicker-free. The display shows up to 30 pictures per second, allowing users to enjoy a vivid live broadcasting. The SGH-P900 supports TV-output function, online browser, personal information manager and series of office functions and features the classic functions of a high quality GSM/GPRS mobile.

In a parallel trend, network operators have introduced personalized Ring Back Tone (RBT) services that enable a subscriber to choose a custom audio clip (e.g., a favorite song) to be played back to a caller phone during a ringing portion of a call, prior to the subscriber answering the call. Hence, instead of hearing a standard ring-back tone (at the caller phone) indicating that a target phone is being alerted of the incoming call connection request, the caller hears the custom audio clip selected by the subscriber. As noted in Application Serial Nos. 20050117726 and 20060013377, the contents of which are incorporated by reference, a common architecture for providing custom ring-back tone includes a Mobile Switching Center (MSC), a Home Location Register (HLR), and a ring-back tone generator. In this architecture, software in a network operator's MSC, in conjunction with the Home Location Register (HLR), identifies which received calls have been placed to corresponding subscribers of the ring-back service. For such calls, the MSC sets up a voice path to the ring-back tone generator for conveying a ring-back tone to the caller phone while also placing an outbound call connection to alert the subscriber of the call placed by the caller phone. The ring-back tone generator then plays the selected audio clip back to the caller through the voice path while the subscriber phone is alerted of the incoming call connection request. When the MSC detects that the subscriber answers his alerting phone, or the target phone abandons the call, the MSC releases the voice path to the ring-back tone generator and continues on with normal call handling. For example, after detecting that the subscriber answers his phone, the MSC breaks a link to the ring-back tone generator and bridges the caller phone to the subscriber phone via a voice communication channel so that the subscriber and the caller can talk with each other without the custom ring-back tone being played.

The mobile devices can communicate using Short Message Service (SMS), a mechanism of delivery of short messages over the mobile networks. In addition to SMS, Smart Messaging (from Nokia), EMS (Enhanced Messaging System) and MMS (Multimedia Messaging Service) have emerged. MMS adds images, text, audio clips and ultimately, video clips to SMS (Short Message Service/text messaging). Once 3G is deployed, MMS can support streaming video. More information on MMS is discussed in United States Patent Application 20010034767, the content of which is incorporated by reference.

Using their mobile devices, users can access the Internet, send and receive email, participate in instant messaging, and perform other operations. Accessing the desired information and customizing their devices, however, may be cumbersome for the user. United States Patent Application 20050278757, the content of which is incorporated herewith, discloses downloading contents such as news, weather, traffic, trivia and watch faces to a watch. The contents are broadcast to mobile electronic devices using a commercial service known as MSN Direct. Using FM radio sub-carrier frequencies, watches with MSN Direct are continuously updated with information wherever coverage exists for the FM network.

### SUMMARY

Various aspects of systems and methods are disclosed to provide custom dial tone based on user preference; to provide ring back video (RBV) to a caller, select a video clip as a ring video for the caller and play the video clip to the caller in response to an incoming call to the mobile device; or to record a message from a caller as video mail when no one answers the call. In another aspect, the system provides glanceable news, weather, etc. in either text or video format delivered through SMS, MMS, multi-cast feeds or RSS feeds. In yet another aspect, the system is multi-protocol and can work with a variety of cellular networks, WiFi networks, or WiMAX networks.

In one aspect, a system includes a network; a first mobile phone to record a video message and send the video message to a video mailbox over the network; and a second mobile phone to retrieve the video message from the video mailbox and play the video message.

Implementations of the above aspect may include one or more of the following. The video mailbox can be a streaming media server, wherein the first mobile phone uploads the video message to the streaming media server after recording, and the second mobile phone downloads the video message from the streaming media server over the network. The second mobile phone can be a voice only phone, wherein the streaming media server transmits only audio to the second mobile phone. The network can be one of: the Internet, an intranet, an extranet, a local-area network (LAN), a wide-area network (WAN), a wired network, a wireless network, a cellular network, a WiMAX network, a WiFi network, an 802 network, an 802.11 network, an 802.16 network, and a telephony network. The video mailbox stores at least one of: voicemail, video mail, streaming audio mail, and streaming video mail.

In another aspect, a system includes a network interface communicatively coupling the system to a wireless network; and a multimedia messaging program to record a multimedia message to send to another user over the network.

In another aspect, a mobile phone includes a processor, a data storage device, a camera, and code to record a video mail and send the video mail to a video mailbox over a network so that a second mobile phone can retrieve the video mail from the video mailbox and play the video message.

In yet another aspect, a mobile device includes a display and a processor coupled to the display. The processor executes code to select a video clip as a ring video; and code to play the video clip in response to an incoming call to the mobile device, wherein the code stops playing the video clip when the incoming call is answered.

Implementations of the above aspect may include one or more of the following. The device has a payment mechanism to charge the user to access each video clip. The payment can be in the form of cash, check, credit card, debit card, or Paypal payments. The device includes code to give the video clip to another subscriber or to request from another subscriber. The device includes code to select a video clip for playing as a ring-back indicator for a predetermined caller; detect a call from the predetermined caller to the recipient; and play the video clip to the predetermined caller as a ring-back indication. The code can also store a video message from a caller when a call is unanswered and code to download and play the video message on demand. The code can provide periodically updated information including news, weather and sports on the display for a glanceable view. For example, the updated information comprises Really Simple Syndication (RSS) channels. The code can customize a dial tone. The device can include a short range radio such as an 802.11 (WiFi) radio, a long range radio such as an 802.16 (WiMAX) radio and a cellular radio connected to the processor.

In another aspect, systems and methods are disclosed to provide ring-back video (RBV) to a mobile device by selecting a video clip for playing as a ring-back indicator for a predetermined caller; detecting a call from the predetermined caller to the recipient; playing the video clip to the predetermined caller as a ring-back indication; and suspending the video clip when the recipient answer the call.

Implementations of the above aspects may include one or more of the following. The system can charge the recipient for the RBV. A video of the recipient can be used as the video clip. The video clip can be an advertisement. The system can store a phone number and a link to the video clip in a database. The video clip can be selected by designating a predetermined video clip to be played as an RBV and a phone number. The user can designate the video clip using a web page or a cellular telephone keypad. A predetermined video segment can be played according to one of: time, date, caller's number, caller group. In addition, in response to a call, the system can automatically display to a user a search result for one of: services, people, products and companies. The search can be refined using an automated position determination using triangulation based location determination, WiFi location determination, GPS, assisted GPS, GLONASS, assisted GLONASS, GALILEO, or assisted GALILEO.

In one aspect, systems and methods are disclosed for receiving and interacting with downloadable content on a mobile phone by receiving a plurality of contents through at least one of the following: a broadcast directed to one or more phones; a direct connection; and a peer connection from another device; and periodically cycling through the received contents and displaying each content for a predetermined period on a display of the phone.

In one aspect, downloadable content can be used instead of the dial tone. For example, a custom dial indication such as scrolling news text, advertisements, music clip or video can be played when the user turns on the phone prior to dialing.

In another aspect, a system to receive and interact with downloadable content on a mobile phone includes a broadcast device configured to broadcast contents to a plurality of mobile electronic devices at the same time and a mobile phone to receive contents through at least one of the following: a broadcast directed to one or more phones; a direct connection; and a peer connection from another device, said phone periodically cycling through the received contents and displaying each content for a predetermined period on a display of the phone.

Implementations of the above aspect may include one or more of the following. The system can receive a sports channel, a phone skin channel, a weather channel, a stocks channel, a news channel, a traffic channel, a movies channel, a secured channel, or a search channel. The phone skin channel selection can include selecting a phone face from a plurality of phone faces. The phone can receive an input from a button (such as a keypad or an up/down button) on the phone indicating the channel to be selected. The contents can be transmitted using SMS protocol, Internet protocol, or encrypted protocol. The phone periodically updates the contents with fresh information. The system allows a user to search information using a search engine. The system can run a predetermined search query on a periodic basis and transmitting a search result over the search channel. The secured channel can include a bank summary, a credit card summary, or a brokerage financial summary, where a user is authenticated prior to displaying the secured channel content.

The broadcast device can be configured to broadcast an FM communication signal, a VHF communication signal, an UHF communication signal, a terrestrial broadcast communication signal, or a digital video broadcast (DVB) communication signal. A server can be configured to receive input from a user to select content to be broadcast. The broadcast device can send a configuration message to the mobile electronic device indicating what watch faces to keep on the mobile electronic device.

Services provided by the system include real-time stock quotes, stock trading, weather updates, traffic alerts, sports scores, flight confirmation, news flashes, currency conversion, online yellow pages, games, mobile banking, mobile stock trading and other location-based, time-sensitive information.

Still other aspects and embodiments of the invention will become apparent by reading the detailed description that follows and by referring to the accompanying drawings.

### BRIEF DESCRIPTION OF THE DRAWINGS

FIG. 1A shows one process for providing video ring.

FIG. 1B shows an exemplary mobile video device playing an exemplary video ring in response to an incoming call.

FIG. 2A shows an exemplary process for providing video ring-back.

FIG. 2B illustrates an exemplary communication system suitable for use in explaining an operation of the ring back video system.

FIG. 3A shows an exemplary process for leaving a video mail as a message instead of voicemail on a mobile device.

FIG. 3B illustrates an exemplary communication system suitable for use in explaining an operation of video mail messaging system.

FIG. 4 shows an organization of network elements in a GSM network supporting messaging

FIG. 5 shows an exemplary reverse look up SMS system that operates with the systems of FIGS. 1-2.

FIG. 6 shows an exemplary process for receiving and interacting with downloadable content on a mobile phone.

FIG. 7 shows an exemplary mobile phone that can communicate through a plurality of wireless radios.

### DESCRIPTION

In the described embodiments below, the electronic devices may be mobile devices, such as smart phones, PDAs, watches, among others, that are configured to receive communication signals. The electronic devices may be configured to receive broadcast transmissions from one or more broadcast towers and are capable of receiving and processing messages from the broadcast transmissions. After information is received and processed by the client device, a user may passively or actively review the information that is stored in the electronic device. The term “content” can be any information that may be stored in an electronic device. By way of example, and not limitation, content may comprise graphical information, textual information, and any combination of graphical, textual information, audio or video information. Content may be displayable information, audiovisual information or auditory information. Audiovisual information may include a single image or a stream of video. Auditory information may include a single sound or a stream of sounds.

Ring Video System

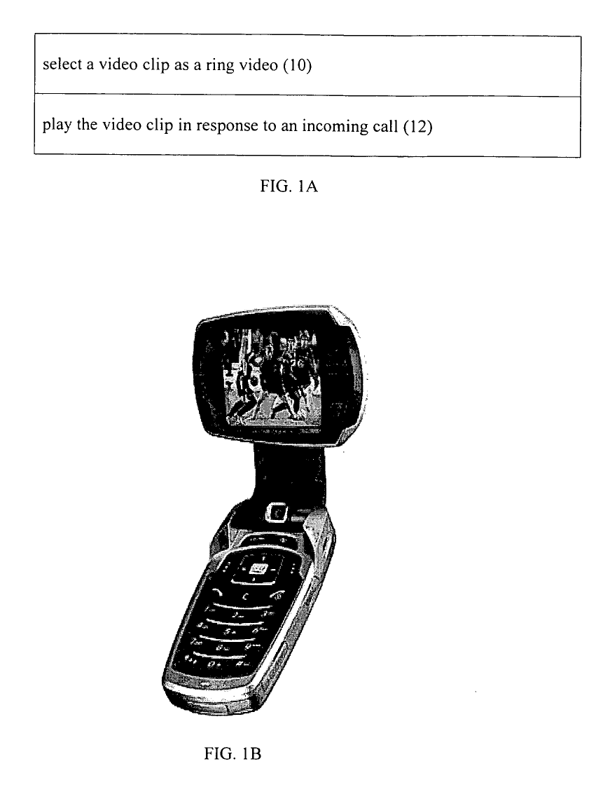

FIG. 1A shows one process for providing video ring while FIG. 1B shows an exemplary mobile video device playing an exemplary video ring in response to an incoming call instead of a fixed ring tone found in conventional phones. In this process, the user selects a video clip as a ring video (10). The video clip can be downloaded to the mobile device through the user's computer, sent using MMS, downloaded through the Internet to the mobile device, or downloaded from an operator service. The video clip can be purchased on-line or can be available free on-line. Next, the system registers the video clip with the mobile system software so that the mobile device plays the video clip in response to an incoming call (12). When a call comes in, the system can play the video clip as a ring indicator using a suitable video player such as Real Player or Microsoft Media Player or animation software such as Macromedia Flash. When the user answers the call, the video ring service is terminated.

Ring Back System

In one aspect, embodiments of the system enable custom ring-back multi-media presentation services. For example, one configuration herein involves use of an MSC (Mobile Switching Center) that redirects handing of a call connection request to a remotely located and independently operating ring-back video generator system. During operation, the ring-back video generator system maintains a first link through the MSC to feed back a custom ring-back video to a caller phone calling a target phone. The ring-back video generator system also maintains a second link through the MSC to alert (e.g., cause the subscriber's phone to ring) a subscriber phone of an incoming call request. Upon detection of a subscriber answering his phone, the ring-back video generator system i) discontinues providing the feedback to the caller phone and ii) bridges the first link and second link so that the caller phone can communicate with the subscriber phone. To free resources of the ring-back video generator system after connecting the caller phone to the subscriber phone, the ring-back video generator system optionally instructs the MSC to bridge the first and second link in lieu of having to provide the bridge at the ring-back video generator system. Freed resources of the ring-back video generator system therefore can be used to handle new calls. An operator can simply reconfigure an existing network to include a new ring-back video generator system or service control system as discussed in more detail below.

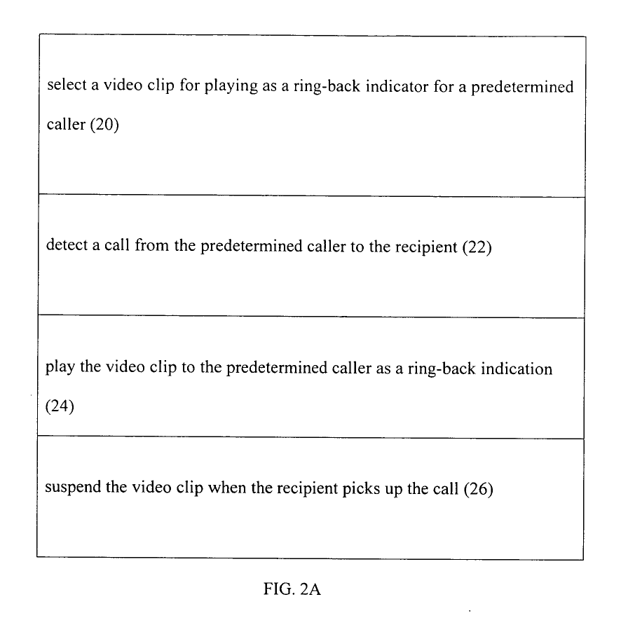

FIG. 2A shows an exemplary embodiment for providing video ring-back. First, the process selects a video clip as a ring-back indicator for a predetermined caller (20). This can be specified in advance by a recipient by specifying a caller number and associating the caller number with a pre-selected video clip. The recipient can specify the ring back video over the web or using the phone keypad. The set-up can also accept payment information such as a credit card or a debit card that the system can charge to the recipient on a per-call basis. During operation, the system waits until a call from the predetermined caller to the recipient is detected (22). The system then plays the video clip to the predetermined caller as a ring-back indication (24). The system suspends or terminates the video clip when the recipient picks up the call (26).

The system enables users to select a video or record a short video segment that the call will see. This is a replacement for the conventional ring back tone and is played until the user answers the call. The ring back video service works with any mobile terminal unlike ring tone services that need to be stored in specific mobile terminals. The system provides various ways to use the service. Specific videos can be designated according to time of day, date, caller's number, or caller's group. The user can send a video to another user as a gift as well. The ring back video service is easier to adopt and translates into greater revenue for mobile operators. The system enables operators to introduce video ring back using any of switch software modification method, Hairpin method, or the IN based method.

FIG. 2B illustrates an exemplary communication system 100 suitable for use in explaining an operation of the ring back video system. The system can also be used to provide video ring service. The following discussion will be used in the context of a system to provide ring back video, and a similar operation also occurs in providing video service. As shown, the communication system 100 includes a caller video phone 110 and a target video phone 120 in communication with network 150. Network 150 includes phone switch system 130 and a multimedia ring back content generator 140 such as a ring-back video generator system. Phone switch system 130 includes table 135 as well as trunk 132-1, trunk 132-2, trunk 132-3, and trunk 132-4 (collectively trunks 132). Ring-back video generator system 140 includes trunk 142-1 and trunk 142-2 (collectively trunks 142). Call connection 124 and call connection 126 define a communication path through respective elements of network 150.

Communication system 100 supports custom ring-back videos for calls to certain subscribers of such a video phone plan. For example, the custom ring-back video service provided by communication system 100 enables a subscriber to choose a custom video clip (e.g., a favorite movie segment or a 30 second sports video) to be played back to a caller phone during a ringing portion of a call, prior to the subscriber answering an attempted call. Thus, instead of hearing a standard ring-back tone (at the caller phone 110) indicating that a target phone 120 is being alerted of the incoming call connection request, the caller phone 110 hears the custom video clip (e.g., a movie) selected by the subscriber.

During general operation, caller video phone 110 initiates a call to target video phone 120 (such as a subscriber of the custom ring-back video service) by transmitting a call connection request 102 to phone switch system 130 such as an MSC. In one configuration, call connection request 102 includes an identifier of the caller phone 110 as well as an identifier of the target phone 120. The phone switch system 130 first compares information such as the identifier of the called party in the call connection request 102 to the table 135 (e.g., a map) to identify whether the called party (e.g., target video phone 120) is a subscriber of an enhanced service requiring interaction with an external peripheral such as the ring-back video generator system. If so, the phone switch system 130 forwards (e.g., hands off) the call connection request 104 to the ring-back video generator system 140 for further call processing to the ring-back video generator system 140. If not, the phone switch system 130 proceeds with normal call handling routines to provide a call connection 122 between the caller phone 110 and the target phone 120 with conventional a ring tone.

When the phone switch system 130 redirects the call connection request 102 to ring-back video generator system 140, the phone switch system 130 forwards call connection request 104 to ring-back video generator system 140 indicating the request by caller phone 110 to connect to target phone 120. In response to receiving call connection request 104, ring-back video generator system 140 transmits a call connection request 106 to phone switch system 130 to establish call connection path 126. Establishing call connection path 126 includes assigning a trunk 142-1 of ring-back video generator system 140 and trunk 132-3 and trunk 132-4 of phone switch system 130 to support communications between the ring-back video generator system 140 and the target phone 130. Call connection path 124 supports communications through trunk 142-1 of ring-back video generator system 140 and through trunk 132-2 and trunk 132-1 to caller phone 110. While alerting the target phone 120 (e.g., causing the target phone 120 to ring) of the incoming call by caller phone 110, the ring-back video generator system 140 provides a custom ring-back video to caller phone 110. When a subscriber of the target phone 120 answers the target phone 120, the ring-back video generator system 140 discontinues the ring-back video on call connection path 124 to caller phone 110 and potentially bridges call connection path 122 (e.g. a first voice communication channel) and call connection path 126 (e.g., a second voice communication channel) via bridge 146 so that a user of caller phone 110 and subscriber of target phone 120 can speak with each other.

In one configuration, after providing bridge 146 to connect the caller phone 110 to the target phone 120, the ring-back video generator system 140 transmits a message to phone switch system 130 requesting the phone switch system 130 to provide a bridge between trunk 132-1 and trunk 132-4. In response, the phone switch system 130 provides bridge 236 as shown in FIG. 2 to free trunk 142-1, trunk 142-2, trunk 132-2, and trunk 132-3. Caller phone 110 couples to target phone 120 via call connection path 222 and call connection path 226.

An exemplary operation of the ring-back video generator system 140 is discussed next in connection with a call connection request to provide a custom ring-back video to caller phone 110. First, ring-back video generator system 140 receives an inbound call connection request 104 forwarded from a phone switch system 130 (such as an MSC) that itself receives the inbound call connection request 102 from a caller phone 110 attempting to connect to a target phone 120 (e.g., a subscriber). The ring-back video generator system 140 initiates generation of a first call connection path 124 on which to provide the customized ring-back video (and/or custom video image data) to the caller phone 110. The ring-back video generator system 140 also transmits, based on receiving the inbound call connection request 124, an outbound call connection request 126 to the phone switch system 130 to establish a second call connection path 126 through the phone switch system 130 to the target phone 120. Consequently, an MSC in a conventional ring-back tone system that normally handles such call processing redirects a call connection request 102 from the caller phone 110 and relies on the ring-back video generator system 140 to handle call processing and provide a custom ring-back tone or video service.

The ring-back video generator system 140 provides a flag associated with the outbound call connection request 106 from the ring-back video generator system 140 to differentiate the outbound call connection request 106 from the inbound call connection request 104. Thus, a phone switch system 130 that utilizes a map or table 135 to identify which received call connection requests to redirect to the ring-back video generator system 140 will not redirect the received outbound call connection request 106 back to the ring-back video generator system 140 in an endless loop.

The ring-back video generator system 140 maintains the first call connection path 124 to include a first trunk 142-1 of the ring-back video generator system 140 and the second call connection path 126 to include a second trunk 142-2 of the ring-back video generator system 140. Based on use of trunks and other resources, the ring-back video generator system 140, therefore, has the ability to receive calls and place calls on different call connection legs (i.e., different call connection paths). One such path can provide a conventional ring back tone or a custom ring back tone such as music for mobile phones that are non-video phones.

Next, the ring-back video generator system 140 communicates with the phone switch system 130 (from which the ring-back video generator system 130 receives the inbound call request 104) to establish the second call connection path 126 through the phone switch system 130. Consequently, in one configuration, both the first call connection path 124 and the second call connection path 126 terminate at the ring-back video generator system 140 and pass through phone switch system 130.

The ring-back video generator system 140 utilizes the second call connection path 126 or related communication path through the phone switch system 130 to at least attempt to alert the target phone 120 of an incoming call from the caller phone 130. For example, while maintaining the first call connection path 124 with the caller phone 110 to eventually provide a custom ring-back video, the ring-back video generator system 140 initiates generation of the second call connection path 126 through the phone switch system 130 to alert the target phone 120 (e.g., the subscriber) of the call connection request by the caller phone 110.

The ring-back video generator system 140 monitors either or both in-band audio signals (e.g., audio signals transmitted on a call connection path) and out-of-band signaling messages (e.g., messages associated with a call connection path but not transmitted over the call connection path) to determine how to handle further call processing. For example, in one configuration, the ring-back video generator system 140 monitors out-of-band signaling messages associated with the second call connection path to i) identify whether the target phone 120 is being alerted of an attempt by the caller phone 110 to connect to the target phone 120 and ii) detect termination of a mode of alerting the target phone 120 of an attempt by the caller phone 110 to connect to the target phone 120.

In another configuration, the ring-back video generator system 140 monitors in-band audio signals on the second call connection path 126 between the ring-back video generator system 140 and the target phone 120 to i) identify whether the target phone 120 is being alerted of an attempt by the caller phone 110 to connect to the target phone 120 and ii) detect termination of a mode of alerting the target phone 120 of an attempt by the caller phone 110 to connect to the target phone 120. The ring-back video generator system 140 can further monitor the in-band and out-of-band signals to detect other conditions as well such as when an attempted call terminates in video-mail or conventional voicemail.

When the ring-back video generator system 140 receives an indication from the phone switch system 130 that the target phone 120 is being alerted (e.g., initiation of ringing the target phone 120) of an attempt by the caller phone 110 to connect to the target phone 120, the ring-back video generator system 140 provides (e.g., transmits) one of multiple custom ring-back videos over the first call connection path 124 to the caller phone 110 in lieu of a standard ring-back tone. The ring-back video generator system 140 determines which ring-back video to play back on the first call connection path 124 to the caller phone 110 depending on an identifier (e.g., phone number) associated with the caller phone 110 and potentially an identifier (e.g., phone number of the subscriber phone) of the target phone 120 being called.

Certain configurations support passing of calling party identification information, including any calling ID presentation restrictions associated with the caller phone 110, received on the first call connection path 124 (e.g., from the phone switch system 130, caller phone 110, etc.) through to a called subscriber associated with the target phone 120 via the second call connection 126, such that the called subscriber can identify a call attempt as being from an actual calling party rather than from the ring-back video generator system 140.

In one configuration, the ring-back video generator system 140 simultaneously monitors out-of-band signaling messages associated with the second call connection path 126 and in-band audio signals on the second call connection path 126 to identify whether the target phone 120 is currently being alerted of an attempt by the caller phone 110 to connect to the target phone 120. This approach can provide better call processing results because the ring-back video generator system 140 can more quickly and definitively detect that the target phone 120 is being alerted and provide a custom ring-back video from the ring-back video generator system 140 over the first call connection path 124 to the caller phone 110.

In certain circumstances, the ring-back video generator system 140 receives an indication from the phone switch system 130 that the target phone 120 cannot be alerted of an attempt by the caller phone 110 to connect to the target phone 120 because a subscriber shut off his phone or the subscriber is currently using his phone and does not have call waiting. In response to such circumstances, the ring-back video generator system 140 system immediately creates bridge 146 between the first call connection path 124 and the second call connection path 126 together in lieu of providing a custom ring-back video to the caller phone 110. Consequently, the caller associated with the caller phone 110 receives a standard network tone (e.g., busy signal) or announcement identifying the reason for the call attempt failure in lieu of a custom ring-back video. Otherwise providing the custom ring-back video in this case may erroneously imply to the user of caller phone 110 that the call request was being placed to the target phone 120 but the subscriber just wasn't answering his target phone 120. Thus, ring-back video generator system 140 can selectively provide standard network tones or announcements to the caller phone 110 instead of a custom ring-back video.

While providing a custom ring-back video, the ring-back video generator system 140 monitors for a trigger condition (e.g., a presence of an in-band audio signal on the second call connection or out-of-band messaging signals) indicating that the target phone 120 is no longer being alerted of an attempt by the caller phone 110 to connect to the target phone 120.

In one configuration, a subscriber can select whether the ring-back video generator system 140 plays a custom audio or video clip (potentially different or the same as the custom ring-back video) during a phone conversation between the caller phone 110 and the target phone 120. If the subscriber selects a video or an audio clip to play in the background during a phone conversation, the ring-back video generator system 140 continues to or starts to provide an appropriate customized video or audio (e.g., music) over the first call connection path 124 and the second call connection path 126 during an active session when a user of the caller phone 110 is able to speak with a user of the target phone 120.

The ring-back video generator system 140 monitors for a trigger condition indicating a forwarding of the second call connection path 126 to an alternative destination instead of the target phone 120. In response to detecting the trigger condition, the ring-back video generator system 140 provides a bridge 146 at the ring-back video generator system 140 between the caller phone 110 and the alternative destination (e.g., another phone device, video mail, voice mail, etc.). In one configuration, the ring-back video generator system 140 utilizes an identifier (e.g., phone number) associated with the alternative destination to determine whether to provide a different custom ring-back video to the caller phone 110 based on being forwarded to the alternative destination. If so, the ring-back video generator system 140 provides a custom ring-back video associated with the alternative destination (and caller phone) over the first call connection path 124 to the caller phone 110. In another embodiment, the generator system 140 can provide a custom dial tone for the phone as well. The dial tone can be based on time of day, month, quarter or year. The dial tone can also be music selected by the user, for example.

The ring-back video generator system 140 optionally provides a bridge 146 between the first call connection path 124 and the call second connection path 126 to couple the caller phone 110 to the target phone 120. In one configuration, the ring-back video generator system 140 passes off a duty of bridging the first call connection path 124 and the second call connection path 126 to the phone switch system 130 in the path of the first call connection path 124 and second call connection path 126 to free up resources (e.g., phone trunks) of the ring-back video generator system 140 for new calls. For example, in step 530, the ring-back video generator system 140 transmits a message from the ring-back video generator system 140 to the phone switch system 130 to initiate establishing a bridge 236 at the phone switch system 130 to connect the caller phone 110 and the target phone 120 in lieu of the bridge 146 in the ring-back video generator system 140. As discussed, the first call connection path 124 and second call connection path 126 pass through the phone switch system 130 that initially redirected the call connection request 104 to the ring-back video generator system 140. The phone switch system 130 may or may not be able to handle this call processing request of providing a bridge 236.

Next, the operation of the phone switch system 130 to support generation of a custom ring-back video to caller phone 110 is described. The phone switch system 130 such as an MSC receives a call connection request originating from a caller phone 110 to establish a call connection between the caller phone 110 and a target phone 120. The phone switch system 130 identifies that the target phone 120 is associated with a subscriber of an unconditional call forwarding service, and that service is activated such that all calls to the subscriber are forwarded to the ring-back video generator system.

The phone switch system 130 redirects the call connection request 102 originating from the caller phone 110 to the ring-back video generator system 140 that provides a customized ring-back video service. In one configuration, the phone switch utilizes an identifier associated with the caller phone 110 to generate an unconditional call forwarding message to the ring-back video generator system 140. This is one example of how the phone switch system 130 forwards the call connection request 102 to the ring-back video generator system 140 rather than directly placing an outgoing call to the target phone 120 itself.

After redirecting the call connection request 104, the phone switch system 130 receives a call connection request 106 from the ring-back video generator system 140 to establish a call connection path between the ring-back video generator system 140 and the target phone 120.

The phone switch system 130 receives call connection request 106 including a second number identifying the target phone 120 as a destination of call connection request 106. In one configuration, the second number is unique with respect to the first identifier number (identifying target phone 120 as the destination of the call) received in call connection request 102. The phone switch system 130 identifies (based on use of the second number) that the call connection request 106 should not be redirected back to the ring-back video generator system 140 and utilizes the second number to place (potentially via normal call processing) a call connection to the target phone 120. As discussed above, use of two different numbers for the same target phone 120 enables the phone switch system 130 and the ring-back video generator system 140 to avoid an endless loop of transmitting the call connection request 104/106 between the phone switch system 130 and the ring-back video generator system 140.

The phone switch system 130 receives a flag associated with the call connection request 106 received from the ring-back video generator 140. The flag provides a signal to differentiate how to handle call processing associated with the call connection request 106. For example, the flag provides an indication to the phone switch system 130 to perform standard call routing in lieu of redirecting the call connection request 106 back to the ring-back video generator system 140. Thus, a call connection request 106 can be based on the same identifier (e.g., phone number of the target phone 120) as in the call connection request 104 or call connection request 102 without causing the call connection request 106 from being passed in an endless loop between the phone switch system 130 and the ring-back video generator system 140.

The phone switch system 130 maintains at least part of a first call connection path 124 (e.g., communication path) between the caller phone 110 and the ring-back video generator system 140 to convey the customized ring-back video service from the ring-back video generator system 140 to the caller phone 110. Additionally, the phone switch system 130 maintains at least part of a second call connection path 126 (e.g., second communication path) from the ring-back video generator system 140 to the target phone 120. The ring-back video generator system 140 utilizes the second communication path through the phone switch system 130 to alert the target phone 120 of an attempt by the caller phone 110 to connect to the target phone 120.

In response to receiving the call connection request 106 from the ring-back video generator system 140, the phone switch system 130 transmits or forwards an alert to the target phone 120 of an attempt by the ring-back video generator system 140 to establish the call connection path 126 between the ring-back video generator system 140 and the target phone 120.

The phone switch system 130 can provide notification to the ring-back video generator system 140 that the target phone 120 is unable to receive the call. This notification prompts the ring-back video generator system 140 to immediately create bridge 146 between the first call connection path 124 and the second call connection path 126, allowing the caller phone 110 to receive the standard network tone or announcement that identifies the reason for the call attempt failure.

For one configuration, if the ring-back video generator system 140 provides a custom ring-back video and the subscriber answers to 120, the ring-back video generator system 140 attempts to hand off bridging of the first call connection path 124 and second call connection path 126 terminating at the ring-back video generator system 140 and passing through the phone switch system 140. For example, in step 820, the phone switch system 130 receives a message from the ring-back video generator system 140 to provide a bridge 236 between the caller phone 110 and the target phone 120 in lieu of coupling the caller phone 110 to the target phone 120 at the ring-back video generator system 140.

The phone switch system 130 may or may not be able to provide the bridge 236 enabling the ring-back video generator system 140 to free up some of its resources. If not, in step 830, the phone switch system 130 notifies the ring-back video generator system 140 of an inability to provide the bridge 236 between the caller phone 110 and the target phone 120 in lieu of coupling the caller phone 110 to the target phone 120 at the ring-back video generator system 140 via bridge 146. In the alternative, if the phone switch system 130 has the ability to provide bridge 236, the phone switch system 130 notifies the ring-back video generator system 140 that the phone switch system 130 can accommodate the handoff request and provide a bridge 236 to connect the caller phone 110 and target phone 120.

In one embodiment, the user can buy the video clip and gift the video clip to another subscriber for use on the other subscriber's enjoyment beyond the ring back video use. In other embodiments, one user can beg the video clip from another user for use in the mobile phone or any other devices.

In one embodiment, the video clip can be an advertisement that is rendered when a particular number is dialed. In this embodiment, merchants pay the operator of the system for the privilege of displaying its ads.

Video Mail System

In another aspect, a video mail system includes a first mobile phone to capture a video message and transmit the video message to a video mailbox over the network; and, a second mobile phone to retrieve the video message from the video mailbox and play the video message.

The video mailbox can be a streaming media server, wherein the first mobile phone uploads to the streaming media server upon the video message being sent to the receiving user over the network, and the second mobile phone downloads the video message from the streaming media server over the network.

The second mobile phone can be a non-video phone, wherein the streaming media server transmits only the voice portion of the video message. The network can be any of the Internet, an intranet, an extranet, a local-area network (LAN), a wide-area network (WAN), a wired network, a wireless network, WiMAX network, WiFi network or a telephony network. The system can store the message in media which can be audio, video, streaming audio, and streaming video.

In one embodiment, the video mail messaging program or code includes composing and recording capability, and optionally may include built-in viewing and playing back capability. Each of these capabilities may be implemented as a software and/or hardware mechanism, component, module, and so on, and each may be considered the means to perform its respective functionality. Other components and capabilities may be included in the program. The message composing and viewing capability may be programmed as a component separate from the component as which the media recording and playback capability is programmed. The composing and recording capability allows a user to compose a message and record media associated with the message, to send to a user over a network via a networking mechanism. The media may be associated with the message as streaming media, a media attached as a file attachment to the message, or in another manner. The viewing and playback capability allows a user to view a message received over a network via a networking mechanism, and play back media associated with the message.

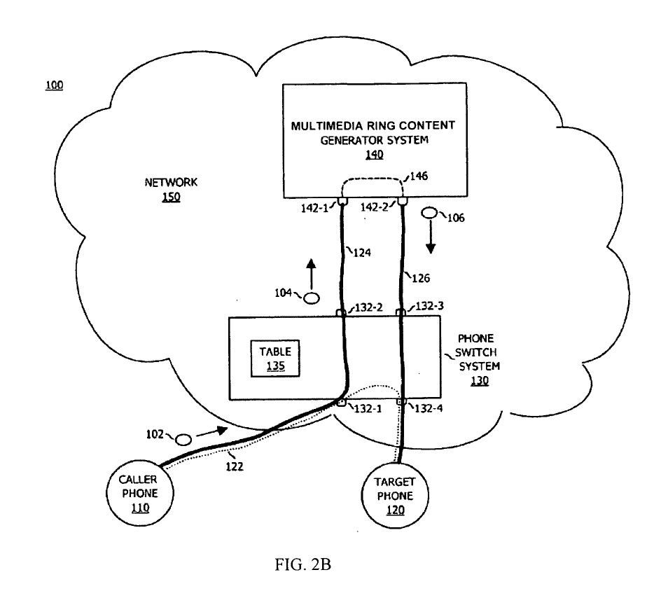

FIG. 3A shows an exemplary process to provide video mail when a caller does not reach a recipient. The process activates a ring video in response to an incoming call for predetermined period (90). If the recipient does not pick up the phone, the process captures a video of a caller who leaves a video message for the recipient. The system stores the video, and provides an indication to a recipient for playback on demand (92). When the recipient is available, he or she notices the indication of a voicemail or video mail, presses a button to retrieve the message, and the process plays back the recorded video message for the recipient to view.

FIG. 3B illustrates an exemplary communication system 160 suitable for use in explaining an operation of a second exemplary video mail system. As shown, the communication system 160 includes a caller video phone 170 and a target video phone 180 in communication with network 150. Network 150 includes phone switch system 130 and a video mail system 141 which can be a server. Phone switch system 130 includes table 135 as well as trunk 132-1, trunk 132-2, trunk 132-3, and trunk 132-4 (collectively trunks 132). Video mail system 140 includes trunk 142-1 and trunk 142-2 (collectively trunks 142). Call connection 174 and call connection 176 define a communication path through respective elements of network 150.

Communication system 160 supports video mails for calls to certain subscribers of such a video phone plan. For example, instead of recording a video of the caller, the custom video mail service provided by communication system 160 enables a subscriber to choose a custom video clip (e.g., a favorite movie segment or a 30 second sports video) to be played back as a message.

During general operation, caller video phone 170 initiates a call to target video phone 180 (such as a subscriber of the video service) by transmitting a call connection request 162 to phone switch system 130 such as a MSC. In one configuration, call connection request 162 includes an identifier of the caller phone 170 as well as an identifier of the target phone 180. The phone switch system 130 first compares information such as the identifier of the called party in the call connection request 162 to the table 135 (e.g., a map) to identify whether the called party (e.g., target video phone 180) is a subscriber of an enhanced service requiring interaction with an external peripheral such as the video mail system 141. If so, the phone switch system 130 forwards (e.g., hands off) the call connection request 174 to the video mail server or system 141 for further call processing to the video mail server or system 141. If not, the phone switch system 130 proceeds with normal call handling routines to provide a call connection 162 between the caller phone 170 and the target phone 180 with conventional voicemail.

When the phone switch system 130 redirects the call connection request 162 to video mail server or system 141, the phone switch system 130 forwards call connection request 164 to video mail server or system 141 indicating the request by caller phone 170 to connect to target phone 130. In response to receiving call connection request 164, video mail server or system 141 transmits a call connection request 166 to phone switch system 130 to establish call connection path 176. Establishing call connection path 176 includes assigning a trunk 142-1 of video mail server or system 141 and trunk 132-3 and trunk 132-4 of phone switch system 130 to support communications between the video mail server or system 141 and the target phone 180. Call connection path 124 supports communications through trunk 142-1 of video mail server or system 141 and through trunk 132-2 and trunk 132-1 to caller phone 170.

In one configuration, a subscriber can select whether the video mail server or system 141 plays a custom video or audio clip (potentially different or the same as the video mail message) during a phone conversation between the caller phone 170 and the target phone 180. If the subscriber selects an audio clip to play in the background during a phone conversation, the video mail server or system 141 continues to or starts to provide an appropriate customized audio (e.g., music) over the first call connection path 174 and the second call connection path 176 during an active session when a user of the caller phone 170 is able to speak with a user of the target phone 180.

The video mail server or system 141 monitors for a trigger condition indicating a forwarding of the second call connection path 176 to an alternative destination instead of the target phone 180. In response to detecting the trigger condition, the video mail server or system 141 provides a bridge 146 at the video mail server or system 141 between the caller phone 170 and the alternative destination (e.g., another phone device, voice mail, etc.). In one configuration, the video mail server or system 141 utilizes an identifier (e.g., phone number) associated with the alternative destination to determine whether to provide a different video mail to the caller phone 170 based on its being forwarded to the alternative destination. If so, the video mail server or system 141 provides a custom video mail associated with the alternative destination (and caller phone) over the first call connection path 174 to the caller phone 170.

In one embodiment, the video clip can be an advertisement that is rendered when a particular number is dialed. In this embodiment, merchants pay the operator of the system for the privilege of displaying its ads.

During operation, a message entered by the user of the client on which the video mail messaging program runs is saved by the video mail messaging program. Concurrently, after, or before the entering and saving of this video mail message, media is recorded and the media may include audio, video, or both audio and video. As the media is recorded, or after it has been entirely recorded, the media is uploaded to a streaming media server over a network. The video mail message is sent over the network to its recipient, with a link or other entity indicating that the message has associated media that has been uploaded to the server.

In a streaming embodiment, a video mail message is received over a network. In response to a user requesting the video mail messaging program to display the message, the video mail message is displayed. This request can be on a per-message basis, such as by the user selecting the particular video mail message, or on a default basis. For instance, the video mail messaging program may have a preview pane in which messages are automatically displayed. The video mail messaging program downloads the associated media from the streaming media server that has been previously uploaded to the server, and plays back this media. Playback may be performed as the media is being downloaded from the server, or after the media has been downloaded from the server in its entirety. Playback can be performed in a number of different manners, and is not limited to integration with the video mail messaging program.

The system advantageously enables users to select a video or record a short greeting that the recipient will be notified about and the recipient can view and hear the video message on demand by downloading the caller video over the network. The video mail messaging program has built-in video and/or audio media recording and/or playback capabilities. Furthermore, in the streaming media embodiment, the recorded media does not actually reside within or as an attachment to an video mail message. Therefore, video mail messages sent by and received with a video mail messaging program according to such an embodiment will not typically exceed individual video mail size and total video mail mailbox size limitations.

Having built-in audio and/or video recording in particular is advantageous for other reasons as well. A user can send video mail with recorded media using his or her everyday video mail messaging program, without having to resort to another program. Thus, the user can use the address book typically found in such a program to select recipients of the video mail, and can easily forward received messages that have video. The user can use the auto-signature option typically found in such a program to automatically append signatures to sent and forwarded messages with video. Such features are not available with separate video mail messaging and media programs. The user may also use audio and/or video when replying to a received video mail message, which is particularly useful in smaller-sized devices that lack full-sized keyboards on which to enter a text reply. Furthermore, having built-in audio and/or video playback allows the user to easily replay recorded messages that were received and that contain video.

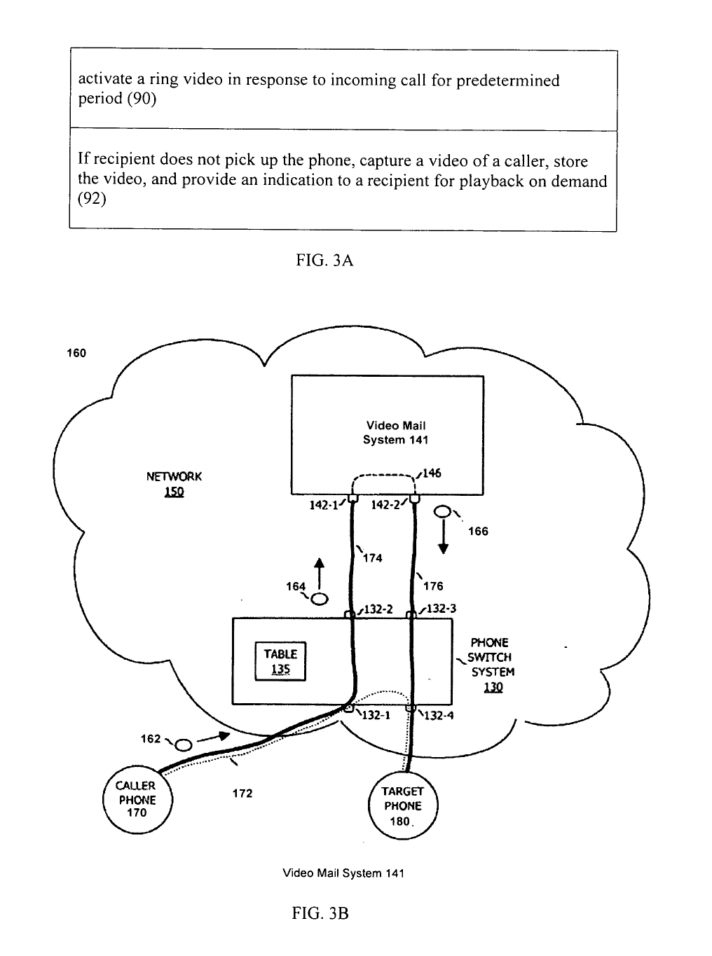

Turning now to FIG. 4, an organization of network elements in a GSM network supporting messaging such as SMS or MMS is shown. It is a store and forward way of transmitting messages to and from mobiles. The message (text only) from the sending mobile is stored in a central short message center (SMSC) which then forwards it to the destination mobile. The SMSC stores/forwards messages to and from the mobile station. The SME (Short Message Entity), which is typically a mobile phone or a GSM modem, can be located in the fixed network or a mobile station, receives and sends short messages. The SMS GMSC (SMS gateway MSC) is a gateway MSC that can also receive short messages. The gateway MSC is a mobile network's point of contact with other networks. On receiving the short message from the short message center, GMSC uses the SS7 network to interrogate the current position of the mobile station form the HLR, the home location register. HLR is the main database in a mobile network. It holds information of the subscription profile of the mobile and also about the routing information for the subscriber, i.e. the area (covered by a MSC) where the mobile is currently situated. The GMSC is thus able to pass on the message to the correct MSC. The MSC (Mobile Switching Center) is the entity in a GSM network which does the job of switching connections between mobile stations or between mobile stations and the fixed network. A VLR (Visitor Location Register) corresponds to each MSC and contains temporary information about the mobile, information like mobile identification and the cell (or a group of cells) where the mobile is currently situated. Using information form the VLR the MSC is able to switch the information (short message) to the corresponding BSS (Base Station System, BSC+BTSs), which transmits the short message to the mobile. The BSS consists of transceivers, which send and receive information over the air interface, to and from the mobile station. This information is passed over the signaling channels so the mobile can receive messages even if a voice or data call is going on.

On embodiment uses streaming video technology to deliver video. Digitally encoded video frames are sent over a cellular carrier's data overlay network in IP packets. The mobile device at the other end reassembles the packets in the correct order, decodes them and displays their contents on its LCD screen. Because of limits on network capacity and the processing power of mobile devices, the video is often less than full motion, which is 30 frames per second (fps). Frame rates for mobile TV vary from one to 15 fps depending on network conditions and techniques used by content providers. In the worst case, images break up into blocks of color, or subscribers see a series of still frames rather than true video.

Another embodiment uses Evolution-Data Optimized, formerly called Evolution-Data Only, abbreviated as EV-DO or 1xEV-DO and often EVDO. In EVDO, voice and data services are provided using separate frequency carriers. That is, the voice and data signals are transmitted over separate forward links defined by different frequency carriers. Initially, the standard was called HDR (High Data Rate), and was renamed to 1xEV-DO after it was ratified by the International Telecommunications Union (ITU); it was given the numerical designation IS-856. Compared to the 1x (1xRTT) networks still being used by operators, or the GPRS and EDGE networks employed by their GSM competitors, 1xEV-DO is significantly faster, providing access terminals (mobile devices) with air interface speeds of up to 2.4576 Mb/s with Rev. 0 and up to 3.1 Mb/s with Rev. A.

When deployed with a voice network, 1xEV-DO requires a separate radio channel of 1.25 MHz. The successor to the first revision of the standard, 1xEV-DO Rev. 0, is called 1xEV-DO Rev. A which supports low latency services including VoIP and Video Telephony on the same carrier with traditional Internet packet data services. Rev. A offers fast packet establishment on both the forward and reverse links along with air interface enhancements that reduce latency and improve data rates. In addition to the increase in the maximum downlink (forward link) data rate from 2.4576 Mb/s in Rev. 0 to 3.1 Mb/s, Rev. A has a 12-times improvement in the maximum uplink (reverse link) data rate, from 0.15 Mb/s to 1.8 Mb/s.

The broadcast device can transmit SMS messages, MMS messages over cellular channels. The broadcast device can also transmit multi-cast messages over the Internet to the mobile devices. The broadcast device can be configured to broadcast an FM communication signal, a VHF communication signal, an UHF communication signal, a terrestrial broadcast communication signal, or a digital video broadcast (DVB) communication signal. A server can be configured to receive input from a user to select content to be broadcast. The broadcast device can send a configuration message to the mobile electronic device indicating what watch faces to keep on the mobile electronic device.

The multimedia message may be a plurality of multimedia elements, such as pictures, text, short video clips and audio clips in electronic format. The address of the intended recipient of the multimedia message associated with the multimedia message can be, for example, the telephone number of the wireless terminal, the logical network address of a computer terminal attached to a GPRS network, or some other address supported by GPRS. Typically, the address is in RFC822 format which is an Internet standard that defines a format in which a logical address can be presented in a form easy for the user to understand. The telephone number of a wireless terminal can also be converted into RFC822 format in an IP network. URL (Uniform Resource Locator) pointers can also be attached to said multimedia message. The address of the intended recipient of the multimedia message in plain RFC822 format, stored in the MMSC, is preferably mapped to a specific identifier, external to the cellular network, which is then used as an identifier for the wireless terminal in communication between the default-GGSN and the MMSC. The external identifier, is preferably not an identifier used to identify the wireless terminal within the cellular network is referred to as an MMS-ID (Multimedia Messaging Service IDentity). To perform the mapping, the MMSC comprises a database, in which information relating to the wireless terminal's multimedia messaging service subscription is stored. The correspondence(s) between the MMS-ID and the wireless terminal's address(es) in RFC822 format are also stored in said database. The MMS-ID is an identifier external to the of the cellular network, a parameter or a set of parameters, which indicates the MMSC from which the wireless terminal MS in question (the owner of the terminal) has subscribed to a multimedia messaging service.

The correspondence between the MMS-ID and the IMSI code of the wireless terminal in question is stored in the GPRS network. The database in which it is stored can be implemented in the GPRS network, for example, by means of a DNS (Domain Name System) server. The IMSI (International Mobile Subscriber Identity) code is used as the principal identifier of the mobile subscriber of the wireless terminal MS within the GPRS network. Typically, the IMSI code is stored in a SIM (Subscriber Identity Module) card. The SIM card is used as a subscriber identity unit in the wireless terminal MS. Thus, when the present description refers to the IMSI code of a wireless terminal, this means the IMSI code of a subscriber known to the network, stored in a SIM card or the like, installed In the wireless terminal MS. Correspondingly, when the description refers to a multimedia message addressed to the wireless terminal MS, this means a multimedia message addressed to the subscriber whose SIM card is in the wireless terminal MS.

Depending on the implementation, the database in which the correspondence(s) between the MMS-ID and the IMSI code of the wireless terminal are stored may be located in different places in the teleoperator's GPRS network. The database should be easy for the default-GGSN to access. Said database can also be implemented in an appropriate manner by means other than a DNS server. It is also possible to integrate said database into the HLR, but preferably this is not done, as there is a desire to keep the amount of data to be stored in the HLR as small as possible.

Alternatively, it is possible to use an internal identifier of the cellular network, such as the wireless terminal's telephone number, as the identifier of the wireless terminal in communication between the GGSN and the MMSC (e.g. in an inquiry according to the invention sent by the MMSC to the default-GGSN). In this case, the database, in which correspondences between the telephone number and the IMSI of the wireless terminal are stored, can be implemented in the cellular network by means of a DNS server. However, in a preferred embodiment of the invention, an identifier such as the MMS-ID, which is external to the cellular network and unequivocally identifies the wireless terminal in question is used.

Search System

In another embodiment, the system can automatically search for publicly (and privately) available information on the parties. In this embodiment, the process determines one or more disambiguating symbols that help refine the subsequent speech recognition and search operation. The disambiguating symbols can be location related symbols such as XY coordinates, GPS coordinates, zip code, area code, city name, among others. The process transmits the search query and the disambiguating symbols over a wireless messaging channel to a search engine. The process improves the recognition accuracy based on the disambiguating symbols as well as the user history. Finally, the process generates a search result based on the search query and the disambiguating symbols.

In addition to free text search, the system can also search predefined categories as well as undefined categories. For examples, the predefined categories can be sports, stocks, flight status, package tracking, price comparison, weather, yellow pages, movie show times, wifi hotspots, news, hotel reservations, drink recipes, jokes, horoscopes, or pickup lines, for example.

In yet other embodiments, the voice SMS search system can provide mobile access to virtually any type of live and on-demand audio content, including Internet-based streaming audio, radio, television or other audio source. Wireless users can listen to their favorite music, catch up on the latest news, or follow their favorite sports.

The system can also automatically send information to the mobile device via text messages. An alert can be created for specific sports teams, leagues, weather reports, horoscopes, stock quotes and more. Alerts can be set on a regular delivery schedule or for event-triggers such as stock quote and sports score changes. Event-triggered alerts keep users informed about real-time changes to things that they care about. For example, sports alerts can provide instant updates at the end of a period, inning, quarter, half, game or golf round for MLB, NBA, NFL, NHL, PGA and all major college sports, instant updates when the score changes (excluding NBA) Stock Alerts, instant updates for user-specified stocks or funds at market open and/or close, or instant updates for designated percentage change in price or specified price targets, among others. “By giving users the choice to receive event-triggered alerts, users can stay current on the latest changes in their portfolio or with their favorite teams, they can make more informed decisions, save time, and stay in the know continuously about subjects and events that are important to them. Event-triggered alerts are an addition to periodic alerts that can be scheduled for delivery at the time and preference of the user. Periodic alerts include 5-day weather forecasts, daily horoscopes, plus sports and stock alerts that can be set to a time of day instead of an event.

In one implementation, an audio alert can be sent. First, an SMS notification (text) announcing the alert is sent to the subscriber's cell phone. A connection is made to the live or on-demand video stream or audio stream. The user listens to the announcement as a live or on-demand stream. The system provides mobile phone users with access to live and on-demand streaming audio in categories such as music, news, sports, entertainment, religion and international programming. Users may listen to their favorite music, catch-up on latest news, or follow their sports team. The system creates opportunities for content providers and service providers, such as wireless carriers, with a growing content network and an existing and flourishing user base. Text-based or online offerings may be enhanced by streaming live and on-demand audio content to wireless users.

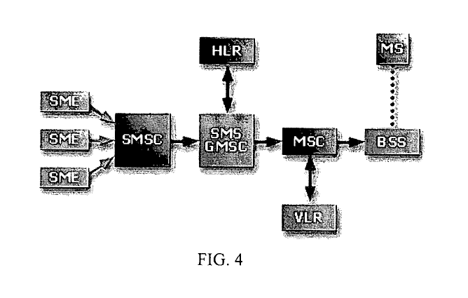

FIG. 5 shows an exemplary reverse look up SMS system. When the user receives an incoming call, the system displays the ring back video and then looks up incoming caller ID (502). This can be done using a telephone directory search in a database or in the cell phone's contact file. Alternatively, the system can search based on the name pronounced by the user's greeting speech. Next, the system supplements a Search Query to locate Employer, Spouse, Family, Hobby or Other Related Information from a Search Engine (504). The system sends an SMS Message with the Search Query to the Search Engine (506). The system then receives and displays one or more Search Results from the Search Engine (508). The system allows the user to scroll and select a Search Result to display more detailed information to the user during the call (510).

Glanceable Information System

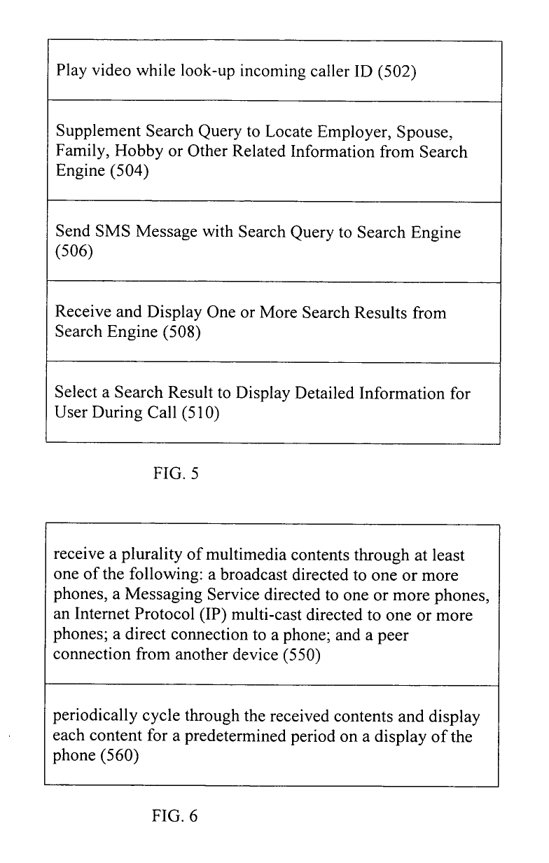

In another aspect, downloadable content is provided for glanceable viewing on mobile devices such as mobile phones. Content may be selected and viewed on a display of the device by means of passive interaction (e.g., hands free operation) or active interaction (e.g., selecting buttons). FIG. 6 shows an exemplary process for receiving and interacting with downloadable content on a mobile phone. The process includes receiving a plurality of contents through at least one of the following: a broadcast directed to one or more phones; a Messaging Service directed to one or more phones, an Internet Protocol (IP) multi-cast directed to one or more phones; a direct connection to a phone; and a peer connection from another device (550); and periodically cycling through the received contents and displaying each content for a predetermined period on a display of the phone (560).

The content can be sent using SMS, MMS, RSS or IP multicast protocols. The direct connection can be done by email, serial port, USB port, wireless USB port, Firewire port, or over a wireless connection using Bluetooth, Zigbee or infrared. The periodic cycling of content allows the user to scan information in a glanceable manner without pressing any phone buttons. The user can set the phone to display information relating to one channel. Alternatively, a glance option scrolls continuously through all channels selected by the user. At any time, the user can press a button to enter a particular channel to view the full details of that channel. For example, when the Headlines screen is scrolling by, the user can press a button to bring up all text associated with a particular headline.

The system brings enhanced functionality to mobile phones and combines personal style and personalized information together into a single accessory. People can choose the style of their phones, change the phone skin/face depending on their mood or environment and be both entertained and informed. Personalized information is delivered in a discrete and glanceable manner.

In one embodiment, the system can receive a sports channel, a phone skin (or phone face) channel, a weather channel, a stocks channel, a news channel, a traffic channel, a movies channel, a secured channel, or a search channel. The phone skin channel selection can include selecting a phone face from a plurality of phone faces. The phone can receive an input from a button (such as a keypad, scrolling key, or an up/down button) on the phone indicating the channel to be selected. The contents can be transmitted using SMS protocol, Internet protocol, or encrypted protocol. The phone periodically updates the contents with fresh information. The system allows a user to search information using a search engine. The system can run a predetermined search query on a periodic basis and transmitting a search result over the search channel. The secured channel can include a bank summary, a credit card summary, or a brokerage financial summary, where a user is authenticated prior to displaying the secured channel content. The user can specify the device to scroll text associated with one channel. Alternatively, a predetermined set of channels or all channels can be rotated for display at the user's selection.

In one implementation, Java software running on the phone wirelessly receives the contents over the Internet or over one or more SMS messages. The data can be pushed to the device or alternatively the device can pull its specific data needs from a server. The pull implementation can send a series of query requests to the server over IP or SMS protocols.

In another embodiment, data is transmitted over RSS, which is an acronym for Really Simple Syndication and Rich Site Summary. RSS is an XML-based format for content distribution. Webmasters create an RSS file containing headlines and descriptions of specific information. RSS is a defined standard based on XML with the specific purpose of delivering updates to web-based content. Using this standard, webmasters provide headlines and fresh content in a succinct manner. Meanwhile, consumers use RSS readers and news aggregators to collect and monitor their favorite feeds in one centralized program or location. Content viewed in the RSS reader or news aggregator is place known as an RSS feed.

The system uses standard, non-proprietary networks to transmit timely and personally relevant information to any digital cell phone device that can handle SMS or MMS or that can access the internet. The system enables even mobile phones with slow transmission speed to provide timely, glanceable information conveniently available on cell phones that people already own. The system offers people a way of staying connected to important information such as news, weather, sports, stocks, and more as well personal messages and appointment reminders. The service delivers tailored services specific to the user's interests and location and discreetly delivers instant personal messages. A subtle vibration or quick glance at the screen alerts the user to a received message. Downloadable phone skins/faces complement the user's personal style and mood.

The system enables mobile phones to provide timely, glanceable information conveniently available on cell phones that people already own. The system offers people a way of staying connected to important information such as news, weather, sports, stocks, and more as well personal messages and appointment reminders. The service delivers tailored services specific to the user's interests and location and discreetly delivers instant personal messages. A subtle vibration or quick glance at the screen alerts the user to a received message. Downloadable phone skins/faces complement the user's personal style and mood. The system brings enhanced functionality to mobile phones and combines personal style and personalized information together into a single accessory. People can choose the style of their phones, change the phone skin/face depending on their mood or environment and be both entertained and informed. Personalized information is delivered in a discrete and glanceable manner.

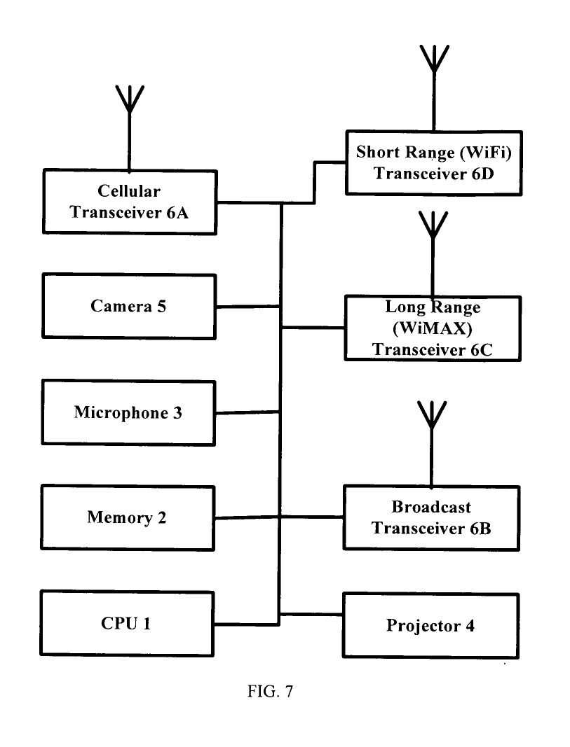

FIG. 7 shows an exemplary portable data-processing device having enhanced wireless access options of cellular, satellite, short range LAN radio, and long range LAN radio. In one embodiment, the device has a processor 1 connected to a memory array 2 that can also serve as a solid state disk. The processor 1 is also connected to a light projector 4, a microphone 3 and a camera 5. A cellular transceiver 6A is connected to the processor 1 to access cellular network including data and voice. The cellular transceiver 6A can communicate with CDMA, GPRS, EDGE or 4G cellular networks. In addition, a broadcast transceiver 6B allows the device to receive satellite transmissions or terrestrial broadcast transmissions. The transceiver 6B supports voice or video transmissions as well as Internet access. The device include a short range radio 6D such as an 802.11 protocol (WiFi) radio, a long range radio 6C such as an 802.16 protocol (WiMAX) radio. Other alternative wireless transceiver can be used. For example, the wireless transceiver can be 802.X, Bluetooth, infra-red, used with one or more, or any combination thereof.

The device can operate with a plurality of transceivers in parallel to increase bandwidth. In this embodiment, a plurality of wireless channels are bonded together and the bonded channels are registered with a particular server which parses the information to be transmitted to each channel to increase overall transmission bandwidth. For example, to transmit HDTV videos, maximum bandwidth is needed and the system can bond WiMAX radios with WiFI radios and, if available, ultrawideband (UWB) or optical radios or transceivers together for simultaneous transmission. In this embodiment, the IP address for each radio or transceiver is sent to an aggregating server which parses blocks of data to be sent to each IP address. The device then combines the packets at the receiving end to result in high transmission bandwidth. One exemplary pseudo-code for this embodiment is as follows:

Check for available radios
Determine bandwidth associated with each radio
Determine total file size to be transmitted
Break file into segments
Allocate segments to each radio for transmission
Receive segments at receiving end and recombine according to

segment sequence

Within each radio type, the process can bond sub-channels for increased transmission bandwidth. For example, in WiMAX radio or GPRS radio, a plurality of bands exist and the system can sense the availability of each band prior to transmission based on packet collisions. For example, the system can sense that a number of sub-channels are available and are spaced within a predetermined frequency of each other. The system increases available transmission bandwidth by transmitting over all available sub-channel frequencies.

In another embodiment to minimize wireless transmission or operation cost, the device can search for the availability of the lowest wireless cost options and use free options first. If none of the free wireless options such as free WiFi wireless access, then the device escalates the wireless access to increasingly expensive options until the device has access. An exemplary pseudo-code for this embodiment is as follows:

Determine cost and bandwidth for each wireless option and sort

option by cost and then by bandwidth

Select with the lowest cost option as current option
While signal for current option is unavailability

Select next cost option

End While
If no signal exists, indicate failure else use the current option

for transmission

If a voice or video call, and if the current option is an open

standard protocol (such as WiFi or WiMAX) then:

Forward calls on Cellular Network to VOIP (Voice

Over IP phone or Video Over IP phone)

Select VOIP as preferred communication method

Else

Select cellular phone as preferred communication
method

End If

For the above pseudo-code, if WiFi and WiMAX signals are available from the home or office for free, then the system would select WiMAX radio as the preferred transceiver for communication and the system would also use VOIP for any voice calls as VOIP is free. The system incrementally changes options until the free options are exhausted. Typically the free options are in the unlicensed wireless bands, while paid options are in the licensed bands. If free options do not exist, then the system looks for cellular network signals to provide users with wireless access, albeit at a higher cost. Thus, in another example, the system would use the following exemplary sequence:

check for the availability of WiMAX in the unlicensed band and if

available, use unlicensed WiMAX network

else check the availability of WiFI in the unlicensed band and if

available, use unlicensed WiFI network

else check availability of any other unlicensed wireless network

and if available, use the unlicensed wireless network

else check availability of licensed terrestrial or satellite

broadcasting network and if available, use the terrestrial or satellite
broadcasting network

else check availability of licensed WiMAX network and if available,

use the licensed WiMAX network

else use the cellular network.

In one embodiment, the system seamlessly switches communication sessions between unlicensed bands in WiFi or WiMAX networks and licensed bands such as cellular networks. The system allows the subscriber to roam outside the range of the unlicensed base station without dropping communications. Instead, roaming outside the range of the unlicensed base station results in a seamless handoff (also referred to as a hand over) wherein communication services are automatically provided by the licensed wireless system. In this embodiment, the unlicensed wireless service generates the interface protocols of a licensed wireless service to provide transparent transition of communication sessions between a licensed wireless service and an unlicensed wireless service. In one embodiment, a mobile station includes level 1, level 2, and level 3 protocols for licensed wireless service and an unlicensed wireless service. Embodiments of the system also permit supplementary GSM services to be provided. GSM has standardized a large number of services. Beyond call origination and termination, the following services shall be supported by the IAN system: Service Standard (Stage 3); Short Message Services 04.11; Supplementary Service Control 04.80; Calling Line Identification Presentation (CLIP) 04.81; Calling Line Identification Restriction (CLIR) 04.81; Connected Line Identification Presentation (CoLP) 04.81; Connected Line Identification Restriction (CoLR) 04.81; Call Forwarding Unconditional 04.82; Call Forwarding Busy 04.82; Call Forwarding No Reply 04.82; Call Forwarding Not Reachable 04.82; Call Waiting (CW) 04.83; Call Hold (CH) 04.83; Multi Party (MPTY) 04.84; Closed User Group (CUG) 04.85; Advice of Charge (AoC) 04.86; User User Signaling (UUS) 04.87; Call Barring (CB) 04.88; Explicit Call Transfer (ECT) 04.91; and Name Identification 04.96. These supplementary services involve procedures that operate end-to-end between the mobile station 102 and the MSC 116. Beyond the basic GSM 04.08 direct transfer application part (DTAP) messages already described for MO and MT calls, the following 04.08 DTAP messages are used for these additional supplementary service purposes: CP-DATA; CP-ACK; CP-ERROR; REGISTER; FACILITY; HOLD; HOLD-ACKNOWLEDGE; HOLD-REJECT; RETRIEVE; RETRIEVE-ACKNOWLEDGE; RETRIEVE-REJECT; RETRIEVE-REJECT; RETRIEVE-REJECT; RETRIEVE-REJECT; USER-INFORMATION; CONGESTION-CONTROL. More details of the seamless switching between unlicensed and licensed networks are disclosed in Application Serial No. 2006/0025147, the content of which is incorporated by reference.

In another embodiment, WiMAX roaming or WiFi roaming can be supported by different operators so that the user would have continuous access to the Internet even if they travel outside of their operators or providers' hot spots. In this embodiment, the user pays a surcharge to be able to roam between WiMAX or WiFi networks of a plurality of operators or network providers. The pseudo code for WiMAX or WiFi roaming is as follows:

check for the availability of WiMAX for preferred provider in the

unlicensed band and if available, use unlicensed WiMAX network of
preferred provider

else check for the availability of WiMAX for roaming provider in

the unlicensed band and if available, register and pay surcharge to use
unlicensed WiMAX network of roaming provider

else check the availability of WiFI in the unlicensed band and if

available, use unlicensed WiFI preferred provider network

else check the availability of any other WiFI in the unlicensed

band and if available, register and pay surcharge to use unlicensed
WiFI roaming provider network

else check availability of any other unlicensed wireless network

and if available, use the unlicensed wireless network

else check availability of licensed terrestrial or satellite

broadcasting network and if available, use the terrestrial or satellite
broadcasting network

else check availability of licensed WiMAX network and if available,

use the licensed WiMAX network

else check for the availability of WiMAX for roaming provider in

the licensed band and if available, register and pay surcharge to use
licensed WiMAX network of roaming provider

else use preferred provider cellular network
else pay roaming charge to use roaming cellular network.

In another implementation, the transceiver 6B can receive XM Radio signals or Sirius signals. XM Radio broadcasts digital channels of music, news, sports and children's programming direct to cars and homes via satellite and a repeater network, which supplements the satellite signal to ensure seamless transmission. The channels originate from XM's broadcast center and uplink to satellites or high altitude planes or balloons acting as satellites. These satellites transmit the signal across the entire continental United States. Each satellite provides 18 kw of total power making them the two most powerful commercial satellites, providing coast-to-coast coverage. Sirius is similar with 3 satellites to transmit digital radio signals. Sirius's satellite audio broadcasting systems include orbital constellations for providing high elevation angle coverage of audio broadcast signals from the constellation's satellites to fixed and mobile receivers within service areas located at geographical latitudes well removed from the equator.

In one implementation, the transceiver 6B receives Internet protocol packets over the digital radio transmission and the processor enables the user to browse the Internet at high speed. The user, through the device, makes a request for Internet access and the request is sent to a satellite. The satellite sends signals to a network operations center (NOC) who retrieves the requested information and then sends the retrieved information to the device using the satellite.

In another implementation, the transceiver 6B can receive terrestrial Digital Audio Broadcasting (DAB) signal that offers high quality of broadcasting over conventional AM and FM analog signals. In-Band-On-Channel (IBOC) DAB is a digital broadcasting scheme in which analog AM or FM signals are simulcast along with the DAB signal The digital audio signal is generally compressed such that a minimum data rate is required to convey the audio information with sufficiently high fidelity. In addition to radio broadcasts, the terrestrial systems can also support internet access. In one implementation, the transceiver 6B can receive signals that are compatible with the Ibiquity protocol.

In yet another embodiment, the transceiver 6B can receive Digital Video Broadcast (DVB) which is a standard based upon MPEG-2 video and audio. DVB covers how MPEG-2 signals are transmitted via satellite, cable and terrestrial broadcast channels along with how such items as system information and the program guide are transmitted. In addition to DVB-S, the satellite format of DVB, the transceiver can also work with DVB-T which is DVB/MPEG-2 over terrestrial transmitters and DVB-H which uses a terrestrial broadcast network and an IP back channel. DVB-H operates at the UHF band and uses time slicing to reduce power consumption. The system can also work with Digital Multimedia Broadcast (DMB) as well as terrestrial DMB.

In yet another implementation, Digital Video Recorder (DVR) software can store video content for subsequent review. The DVR puts TV on the user's schedule so the user can watch the content at any time. The DVR provides the power to pause video and do own instant replays. The user can fast forward or rewind recorded programs.

In another embodiment, the device allows the user to view IPTV over the air. Wireless IPTV (Internet Protocol Television) allows a digital television service to be delivered to subscribing consumers using the Internet Protocol over a wireless broadband connection. Advantages of IPTV include two-way capability lacked by traditional TV distribution technologies, as well as point-to-point distribution allowing each viewer to view individual broadcasts. This enables stream control (pause, wind/rewind etc.) and a free selection of programming much like its narrowband cousin, the web. The wireless service is often provided in conjunction with Video on Demand and may also include Internet services such as Web access and VOIP telephony, and data access (Broadband Wireless Triple Play). A set-top box application software running on the processor 210 and through cellular or wireless broadband internet access, can receive IPTV video streamed to the handheld device.

IPTV covers both live TV (multicasting) as well as stored video (Video on Demand VOD). Video content can be MPEG protocol. In one embodiment, MPEG2TS is delivered via IP Multicast. In another IPTV embodiment, the underlying protocols used for IPTV are IGMP version 2 for channel change signaling for live TV and RTSP for Video on Demand. In yet another embodiment, video is streamed using the H.264 protocol in lieu of the MPEG-2 protocol. H.264, or MPEG-4 Part 10, is a digital video codec standard, which is noted for achieving very high data compression. It was written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part 10 standard (formally, ISO/IEC 14496-10) are technically identical, and the technology is also known as AVC, for Advanced Video Coding. H.264 is a name related to the ITU-T line of H.26x video standards, while AVC relates to the ISO/IEC MPEG side of the partnership project that completed the work on the standard, after earlier development done in the ITU-T as a project called H.26L. It is usual to call the standard as H.264/AVC (or AVC/H.264 or H.264/MPEG-4 AVC or MPEG-4/H.264 AVC) to emphasize the common heritage. H.264/AVC/MPEG-4 Part 10 contains features that allow it to compress video much more effectively than older standards and to provide more flexibility for application to a wide variety of network environments. H.264 can often perform radically better than MPEG-2 video—typically obtaining the same quality at half of the bit rate or less. Similar to MPEG-2, H.264/AVC requires encoding and decoding technology to prepare the video signal for transmission and then on the screen 230 or substitute screens (STB and TV/monitor, or PC). H.264/AVC can use transport technologies compatible with MPEG-2, simplifying an up-grade from MPEG-2 to H.264/AVC, while enabling transport over TCP/IP and wireless. H.264/AVC does not require the expensive, often proprietary encoding and decoding hardware that MPEG-2 depends on, making it faster and easier to deploy H.264/AVC solutions using standards-based processing systems, servers, and STBs. This also allows service providers to deliver content to devices for which MPEG-2 cannot be used, such as PDA and digital cell phones.

The H.264/AVC encoder system in the main office turns the raw video signals received from content providers into H.264/AVC video streams. The streams can be captured and stored on a video server at the headend, or sent to a video server at a regional or central office (CO), for video-on-demand services. The video data can also be sent as live programming over the network. Standard networking and switching equipment routes the video stream, encapsulating the stream in standard network transport protocols, such as ATM. A special part of H.264/AVC, called the Network Abstraction Layer (NAL), enables encapsulation of the stream for transmission over a TCP/IP network. When the video data reaches the handheld device through the transceiver 6B, the application software decodes the data using a plug-in for the client's video player (Real Player and Windows Media Player, among others).

In addition to the operating system and user selected applications, another application, a VOIP phone application executes on the processing unit or processor 1. Phone calls from the Internet directed toward the mobile device are detected by the mobile radio device and sent, in the form of an incoming call notification, to the phone device (executing on the processing unit 1). The phone device processes the incoming call notification by notifying the user by an audio output such as ringing. The user can answer the incoming call by tapping on a phone icon, or pressing a hard button designated or preprogrammed for answering a call. Outgoing calls are placed by a user by entering digits of the number to be dialed and pressing a call icon, for example. The dialed digits are sent to the mobile radio device along with instructions needed to configure the mobile radio device for an outgoing call using either the cellular transceiver 6A or the wireless broadcast transceiver 6B. If the call is occurring while the user is running another application such as video viewing, the other application is suspended until the call is completed. Alternatively, the user can view the video in mute mode while answering or making the phone call.

The light projector 4 includes a light source such as a white light emitting diode (LED) or a semiconductor laser device or an incandescent lamp emitting a beam of light through a focusing lens to be projected onto a viewing screen. The beam of light can reflect or go through an image forming device such as a liquid crystal display (LCD) so that the light source beams light through the LCD to be projected onto a viewing screen.

Alternatively, the light projector 4 can be a MEMS device. In one implementation, the MEMS device can be a digital micro-mirror device (DMD) available from Texas Instruments, Inc., among others. The DMD includes a large number of micro-mirrors arranged in a matrix on a silicon substrate, each micro-mirror being substantially of square having a side of about 16 microns.

Another MEMS device is the grating light valve (GLV). The GLV device consists of tiny reflective ribbons mounted over a silicon chip. The ribbons are suspended over the chip with a small air gap in between. When voltage is applied below a ribbon, the ribbon moves toward the chip by a fraction of the wavelength of the illuminating light and the deformed ribbons form a diffraction grating, and the various orders of light can be combined to form the pixel of an image. The GLV pixels are arranged in a vertical line that can be 1,080 pixels long, for example. Light from three lasers, one red, one green and one blue, shines on the GLV and is rapidly scanned across the display screen at a number of frames per second to form the image.

In one implementation, the light projector 4 and the camera 5 face opposite surfaces so that the camera 5 faces the user to capture user finger strokes during typing while the projector 4 projects a user interface responsive to the entry of data. In another implementation, the light projector 4 and the camera 5 on positioned on the same surface. In yet another implementation, the light projector 4 can provide light as a flash for the camera 5 in low light situations.

The mobile phone includes a series of buttons or scrollable keypads which are arranged to operate as part of a user interface (UI). Each button may have a default function and/or a context determined function. The currently selected channel determines the context for each button. Alternatively, the currently active display may determine the context for each button. For example, a display screen (e.g., a help screen) may be superimposed on the main display such that the display screen becomes the active context. The phone is context sensitive in that the function that is associated with each button may change based on the selected channel or display screen. A user may customize his/her channels through user web site or by setting options directly on the phone. Using the website, the user may set options and select information associated with channels to which the user has subscribed. Channel information and various options may also be automatically retrieved from a web site to which the user participates in. For example, the web site may be the user's log-in home page in which the user has already selected various options customizing the page. These options may be used to populate the options associated with various channels. For example, a user's selected cities may be used in a weather channel, the user's selected theaters may be used in a movies channel, the user's selected stocks they desire to track may be used in a stock channel, the user's favorite search keywords may be used in the search channel, the user's favorite shops or restaurants or pubs may be used in the stores channel and the like.

Multimedia Editing

In yet another embodiment, as part of the content upload, the user captures and edits video taken with a camcorder, camera or cell phones. The user performs simple edits to the video segment using code stored in the mobile device. The system allows the editing user more creative freedom at each step in the process, such as being able to preview and correct each edit decision on the fly. The video editing process becomes similar to putting together a document or graphics presentation where the user cuts and pastes the segments together adding effects and titles.

The software can provide Linear Editing where the content can only be edited sequentially similar to older mechanical techniques of cutting films to perform the edit functions. The software can alternatively provide Non-Linear Editing where editing in this environment is essentially is a visual Cut-and-Paste method and the user can edit any part of the video at will.

The system can provide In-Camera Editing: Video shots are structured in such a way that they are shot in order and of correct length. In another embodiment, the system allows the user to assemble edit: Video shots are not structured in a specific order during shooting but are rearranged and unneeded shots deleted at the time of transferring (copying). This process requires at the least, a Camcorder and VCR. the original footage remains intact, but the rearranged footage is transferred to a new tape. Each scene or cut is “assembled” on a blank tape either one-at-a-time or in a sequence. The system can provide two types of Assemble Editing: 1) A Roll—Editing from a single source, with the option of adding an effect, such as titles or transitioning from a frozen image the start of the next cut or scene and 2) A/B Roll—Editing from a minimum of two sources or Camcorders and recording to a third source. The system can also support insert editing where New material is recorded over existing footage. This technique can be used during the original shooting process or during a later editing process. The system provides Titles on Cardboard, Paper, or other Opaque Media—Painting titles on opaque media and recording the pages on videotape and inserting or assembling the title between scenes, previously shot, during the editing process.

The system supports Sound Mixing where two or more sound sources can be connected to a sound mixer and then inputted into the video. The system also supports Audio Dubbing for adding audio to footage that is already edited together or previously shot. The audio is added to the video tape without altering the previously recorded video and, in some cases, without altering the previously recorded audio.

The above process is suitable for editing consumer produced content which tends to be short. In certain contents such as news or movies that take too long to transmit or view, the contents need to be reduced into chunks of one, five, ten or fifteen minutes, for example, to allow easy viewing while the user is traveling or otherwise don't have full attention on the device for an extended period. In one embodiment, video is micro-chunked to reduce entertainment to its simplest discrete form, be it a blog post, a music track, or a skit. Next, the system makes the content available and lets people download, view, read, or listen. The system lets consumers subscribe to content through RSS- and podcast-style feeds so they can enjoy it wherever and whenever they like. Optionally, the system can put ads and tracking systems into the digital content itself to provide revenue. In one implementation, the system provides microchunk videos entirely free, but it plays in a pop-up window alongside an ad or alternatively short commercials also play before some segments. The microchunks can be e-mailed, linked to, searched for, downloaded, remixed, and made available on-line.

The user or producer can embed meta data into the video or music. Exemplary meta data for video or musical content such as CDs includes artist information such as the name and a list of albums available by that artist. Another meta data is album information for the title, creator and Track List. Track metadata describes one audio track and each track can have a title, track number, creator, and track ID. Other exemplary meta data includes the duration of a track in milliseconds. The meta data can describe the type of a release with possible values of: TypeAlbum, TypeSingle, TypeEP, TypeCompilation, TypeSoundtrack, TypeSpokenword, TypeInterview, TypeAudiobook, TypeLive, TypeRemix, TypeOther. The meta data can contain release status information with possible values of: StatusOfficial, StatusPromotion, StatusBootleg. Other meta data can be included as well.

The meta-data can be entered by the musician, the producer, the record company, or by a music listener or purchaser of the music. In one implementation, a content buyer (such as a video buyer of video content) can store his or her purchased or otherwise authorized content on the server in the buyer's own private directory that no one else can access. When uploading the multimedia files to the server, the buyer annotates the name of the files and other relevant information into a database on the server. Only the buyer can subsequently download or retrieve files he or she uploaded and thus content piracy is minimized. The meta data associated with the content is stored on the server and is searchable and accessible to all members of the community, thus facilitating searching of multimedia files for everyone.

In one implementation that enables every content buyer to upload his/her content into a private secured directory that cannot be shared with anyone else, the system prevents unauthorized distribution of content. In one implementation for music sharing that allows one user to access music stored by another user, the system pays royalty on behalf of its users and supports the webcasting of music according to the Digital Millennium Copyright Act, 17 U.S.C. 1114. The system obtains a statutory license for the non-interactive streaming of sound recordings from Sound Exchange, the organization designated by the U.S. Copyright Office to collect and distribute statutory royalties to sound recording copyright owners and featured and non featured artists. The system is also licensed for all U.S. musical composition performance royalties through its licenses with ASCAP, BMI and SESAC. The system also ensures that any broadcast using the client software adheres to the sound recording performance complement as specified in the DMCA. Similar licensing arrangements are made to enable sharing of images and/or videos/movies.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A mobile device, comprising:
a display; and
a processor coupled to the display and having:
code to select a video clip as a ring video; and
code to play the video clip in response to an incoming call to the mobile device, wherein the code stops playing the video clip when the incoming call is answered.

2. The device of claim 1, comprising payment code to access each video clip.

3. The device of claim 1, comprising code to give the video clip to another subscriber or request the video clip from another subscriber.

4. The device of claim 1, comprising code to:
select a video clip for playing as a ring-back indicator for a predetermined caller;
detect a call from the predetermined caller to the recipient; and
play the video clip to the predetermined caller as a ring-back video (RBV).

5. The device of claim 1, comprising code to ring the mobile phone for a predetermined period in response to an incoming call; code to leave a video message from a caller when the mobile phone does not answer the incoming call; and code to download and play the video message on demand.

6. The device of claim 1, comprising code to provide periodically updated information including news, weather and sports on the display for a glanceable view.

7. The device of claim 6, wherein the updated information comprises Really Simple Syndication (RSS) channels.

8. The device of claim 1, comprising code to customize a dial tone.

9. The device of claim 1, comprising:
an 802.11 protocol radio coupled to the processor;
an 802.16 protocol radio coupled to the processor; and
a cellular radio coupled to the processor.

10. The device of claim 1, comprising:
a local area network radio coupled to the processor;
a metropolitan network radio coupled to the processor; and
a cellular radio coupled to the processor.

11. The device of claim 1, comprising:
a WiFi radio coupled to the processor;
a WiMAX radio coupled to the processor; and
a cellular radio coupled to the processor.

12. The device of claim 1, comprising code to bond a plurality of radios to increase bandwidth.

13. The device of claim 1, comprising code to preferentially select one radio from two or more radios with the cheapest transmission cost and to preferentially make telephone calls using VOIP.

14. A system to provide ring-back video (RBV), comprising:
a ring-back video generator;
a telephone switch coupled to the ring-back video generator; and
a caller mobile device wirelessly coupled to the telephone switch, the caller mobile device receiving and playing a video clip for playing as a ring-back indication to a caller and suspending the video clip when the recipient picks up the call.

15. The system of claim 14, wherein the recipient pays for the RBV.

16. The system of claim 14, wherein the video clip comprises a recording of the recipient.

17. The system of claim 14, comprising a database to store a phone number and a link to the video clip.

18. The system of claim 14, wherein the recipient designates a predetermined video clip to be played as the RBV and a phone number.

19. The system of claim 14, wherein the recipient designates a video clip for the RBV using one of: a web page, a cellular telephone keypad.

20. The system of claim 14, wherein the recipient designates a predetermined video segment to be played according to one of: time, date, caller's number, caller group.
